(19) United States
(12) Patent Application Publication
(10) Pub. No.: US 2025/0192678 A1
(43) Pub. Date: Jun. 12, 2025

(54) POWER CONVERSION DEVICE AND METHOD FOR POWER CONVERSION

(71) Applicant: COMPAL ELECTRONICS, INC., Taipei City (TW)

(72) Inventors: Ho-Nien Yu, Taipei City (TW); Ching-Sung Kao, Taipei City (TW)

(73) Assignee: COMPAL ELECTRONICS, INC., Taipei City (TW)

(21) Appl. No.: 18/970,860

(22) Filed: Dec. 5, 2024

Related U.S. Application Data
(60) Provisional application No. 63/607,104, filed on Dec. 7, 2023.

(51) Int. Cl. H02M 3/158; H02J 7/00; H02M 1/32

(52) U.S. Cl. CPC H02M 3/158; H02J 7/00712; H02M 1/32; H02J 2207/20

(57) ABSTRACT

Disclosed are a power conversion device and a method for power conversion. A voltage conversion device includes a voltage input terminal, a voltage output terminal, a voltage detection selector, a buck conversion circuit, and a bypass control circuit. The voltage detection selector detects whether the input voltage is greater than a predetermined voltage to generate a first enable signal and a second enable signal. The buck conversion circuit receives the second enable signal. When the second enable signal is enabled, the buck conversion circuit converts the input voltage to a converted voltage that is less than or equal to the predetermined voltage, and provides the converted voltage to the voltage output terminal. The bypass control circuit receives the first enable signal. When the first enable signal is enabled, the bypass control circuit provides the input voltage from the voltage input terminal to the voltage output terminal.

### CROSS-REFERENCE TO RELATED APPLICATION

This application claims the priority benefit of U.S. provisional application Ser. No. 63/607,104, filed on Dec. 7, 2023. The entirety of the above-mentioned patent application is hereby incorporated by reference herein and made a part of this specification.

### BACKGROUND

### Technical Field

The present disclosure relates to a power supply and power conversion technology, and particularly relates to a power conversion device.

### Description of Related Art

Electronic devices may obtain the required electricity through a power supply device, or store this electricity in an energy storage device (such as a battery) configured in the electronic device. Currently, consumer electronic devices often use Universal Serial Bus (USB) interfaces as power sources, therefore the USB interfaces of these consumer electronic devices comply with the USB Power Delivery (PD) charging protocol.

Based on the gradual update of the USB PD charging protocol, the current USB PD 3.1 charging protocol may support input power up to 48 volts (V) and power supply of 240 watts (W). However, since the input power of previous USB PD charging protocols (such as PD 2.0, PD 3.0) is about 20V, in order to make consumer electronic devices comply with the current USB PD 3.1 charging protocol, a power conversion device (for example, a buck-boost converter) may be used to convert the input power to a voltage less than or equal to 20V, so as to successfully supply power to consumer electronic devices. However, buck-boost converters cost more and have circuit complexity. Moreover, if the input power is between 5V and 20V, two stages of power conversion (first stage: buck-boost converter; second stage: NVDC voltage conversion circuit set in accordance with previous USB PD charging protocol) are required to supply power, thereby resulting in deteriorated power conversion efficiency.

### SUMMARY

The present disclosure provides a power conversion device and a method for power conversion, which may selectively enable one of two power paths by detecting input voltage to improve power conversion efficiency under light load, thereby achieving energy saving.

In an embodiment of the present disclosure, a voltage conversion device includes a voltage input terminal, a voltage output terminal, a voltage detection selector, a buck conversion circuit, and a bypass control circuit. The voltage input terminal is configured to obtain an input voltage. The voltage output terminal is configured to provide an output voltage. The voltage detection selector is coupled to the voltage input terminal and configured to detect whether the input voltage is greater than a predetermined voltage to generate a first enable signal and a second enable signal. In the case where the input voltage is greater than the predetermined voltage, the first enable signal changes from enable to disable, and the second enable signal changes from disable to enable. The buck conversion circuit is coupled to the voltage input terminal and the voltage output terminal and configured to receive the second enable signal. In the case where the second enable signal is enabled, the buck conversion circuit converts the voltage value of the input voltage to a converted voltage that is less than or equal to the predetermined voltage, and provides the converted voltage to the voltage output terminal. The bypass control circuit is coupled to the voltage input terminal and the voltage output terminal and configured to receive the first enable signal. In the case where the first enable signal is enabled, the bypass control circuit provides the input voltage from the voltage input terminal to the voltage output terminal.

In an embodiment of the present disclosure, the method for power conversion is applicable to a voltage conversion device including a buck conversion circuit and a bypass control circuit. The method for power conversion includes the following steps: detecting whether the input voltage of the voltage conversion device is greater than a predetermined voltage to generate a first enable signal and a second enable signal, wherein in the case where the input voltage is greater than the predetermined voltage, the first enable signal changes from enable to disable, and the second enable signal changes from disable to enable; in the case where the first enable signal is enabled, providing the input voltage to the voltage output terminal of the voltage conversion device through the bypass control circuit; and, in the case where the second enable signal is enabled, converting the voltage value of the input voltage to a converted voltage lower than or equal to the predetermined voltage through the buck conversion circuit, and providing the converted voltage to the voltage output terminal.

Based on the above, the power conversion device and method for power conversion in the embodiments of the present disclosure set up two power paths in the power conversion device, wherein one power path converts the input voltage to a converted voltage less than or equal to a predetermined voltage (e.g., 20V) through the buck conversion circuit, and the other power path provides the input voltage directly to the voltage output terminal through the bypass control circuit. The voltage detection selector detects whether the input voltage is greater than the predetermined voltage (e.g., 20V) to selectively enable one of the aforementioned two power paths, thereby realizing the optimal power path selection under different input voltage ranges, improving the power conversion efficiency at light load, and complying with the USB PD 3.1 charging protocol.

### BRIEF DESCRIPTION OF THE DRAWINGS

FIG. 1 is a schematic diagram of a voltage conversion device according to an embodiment of the present disclosure.

FIG. 2 is an exemplary circuit diagram of the voltage detection selector in FIG. 1.

FIG. 3 is an exemplary circuit diagram of the buck conversion circuit in FIG. 1.

FIG. 4 is an exemplary circuit diagram of the bypass control circuit in FIG. 1.

FIG. 5 is a schematic diagram of various signals in FIG. 2.

FIG. 6 is a flow chart of a method for power conversion according to an embodiment of the present disclosure.

### DESCRIPTION OF THE EMBODIMENTS

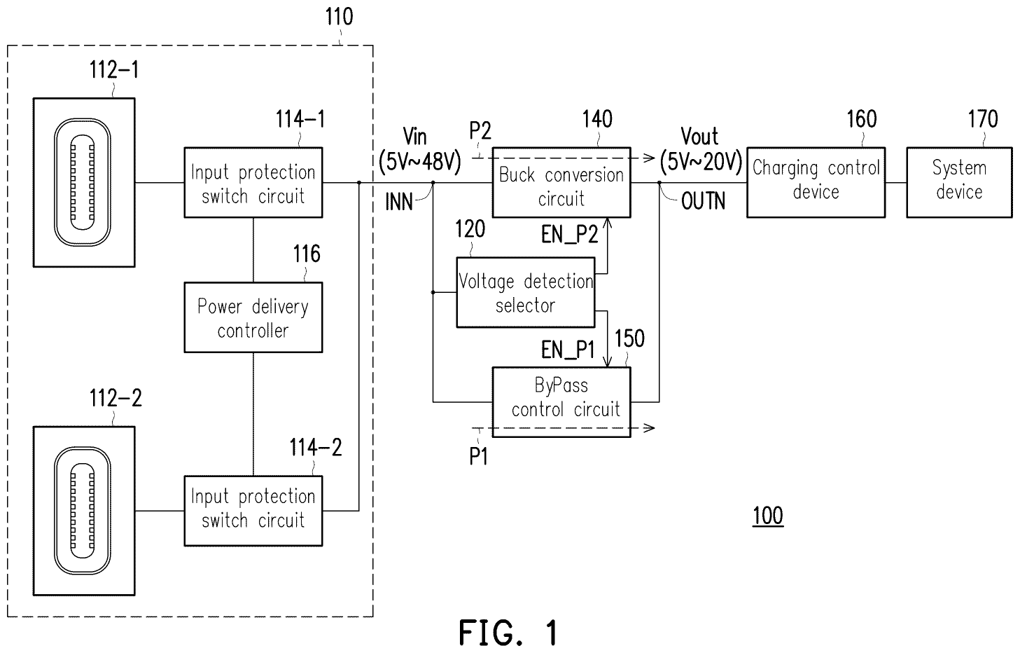

FIG. 1 is a schematic diagram of a voltage conversion device 100 according to an embodiment of the present disclosure. The voltage conversion device 100 may be implemented in an electronic device (such as a laptop computer, tablet computer, desktop computer, smartphone), or in a power supply device (such as a power adaptor) corresponding to the electronic device.

The voltage conversion device 100 includes a voltage input terminal INN, a voltage output terminal OUTN, a voltage detection selector 120, a buck conversion circuit 140, and a bypass control circuit 150. The voltage input terminal INN is configured to obtain an input voltage Vin. The voltage output terminal OUTN is configured to provide an output voltage Vout. In this embodiment, the voltage range of the input voltage Vin may be 5V to 48V to comply with the USB PD 3.1 charging protocol.

The voltage detection selector 120 is coupled to the voltage input terminal INN. The voltage detection selector 120 detects whether the input voltage Vin is greater than a predetermined voltage (e. g., 20V) to generate a first enable signal EN_P1 and a second enable signal EN_P2. Specifically, in the case where the voltage conversion device 100 is just enabled, the first enable signal EN_P1 is enabled and the second enable signal EN_P2 is disabled. Moreover, in the case where the input voltage Vin is greater than the predetermined voltage (20V), the first enable signal EN_P1 changes from enabled to disabled, and the second enable signal EN_P2 changes from disabled to enabled.

The buck conversion circuit 140 is coupled to the voltage input terminal INN and the voltage output terminal OUTN. In this embodiment, the buck conversion circuit 140 is considered as the second power path P2. The buck conversion circuit 140 receives the second enable signal EN_P2. In the case where the second enable signal EN_P2 is enabled, that is, when the voltage value of the input voltage Vin is greater than 20V, the buck conversion circuit 140 will be enabled to convert the voltage value of the input voltage Vin to a converted voltage that is less than or equal to the predetermined voltage (20V), and provide this converted voltage to the voltage output terminal OUTN. On the other hand, in the case where the second enable signal EN_P2 is disabled, the buck conversion circuit 140 will not be enabled and will not provide voltage to the voltage output terminal OUTN. In other words, in the case where the second enable signal EN_P2 is disabled, the second power path P2 is disconnected.

The bypass control circuit 150 is coupled to the voltage input terminal INN and the voltage output terminal OUTN. In this embodiment, the bypass control circuit 150 is considered as the first power path P1. The bypass control circuit 150 is configured to receive the first enable signal EN_P1. In the case where the first enable signal EN_P1 is enabled, that is, when the voltage value of the input voltage Vin is less than or equal to 20V, the bypass control circuit 150 will be enabled to directly provide the input voltage Vin on the voltage input terminal INN to the voltage output terminal OUTN, and the bypass control circuit 150 will not perform voltage conversion or corresponding processing on the input voltage Vin. On the other hand, in the case where the first enable signal EN_P1 is disabled, the bypass control circuit 150 will not be enabled and will not provide the input voltage Vin to the voltage output terminal OUTN. In this embodiment, the buck conversion circuit 140 and the bypass control circuit 150 are controlled by the second enable signal EN_P2 and the first enable signal EN_P1 respectively, and the buck conversion circuit 140 and the bypass control circuit 150 will provide voltage to the voltage output terminal OUTN at different times. In other words, the buck conversion circuit 140 and the bypass control circuit 150 are not be enabled simultaneously.

The voltage conversion device 100 further includes an input circuit 110 coupled to the voltage input terminal INN, a charging control device 160, and a system device 170. The input circuit 110 includes at least one universal serial bus port (e.g., universal serial bus ports 112-1 and 112-2 in FIG. 1), at least one input protection switch circuit (e.g., input protection switch circuits 114-1 and 114-2 in FIG. 1), and a power delivery controller 116. Users may introduce external power supply to the voltage conversion device 100 through the universal serial bus ports 112-1 and 112-2 and cables compliant with the universal serial bus. The input protection switch circuits 114-1 and 114-2 are configured to provide electrostatic discharge (ESD) protection for the universal serial bus ports 112-1 and 112-2, and may provide overvoltage protection for the input voltage Vin. The first terminals of the input protection switch circuits 114-1 and 114-2 are coupled to the output terminals of the universal serial bus ports 112-1 and 112-2 respectively. The second terminals of the input protection switch circuits 114-1 and 114-2 are both coupled to the voltage input terminal INN. The power delivery controller 116 may be coupled to the input protection switch circuits 114-1 and 114-2 to control the power delivery of the universal serial bus ports 112-1 and 112-2 in FIG. 1. The charging control device 160 is coupled to the voltage output terminal OUTN. The charging control device 160 supplies power to the system device 170 (e. g., motherboard, processor, battery-powered devices, etc.) based on the voltage on the voltage output terminal OUTN.

In an embodiment of the disclosure, the charging control device 160 may mainly process power supplies with predetermined voltage (20V) or less. Therefore, when the input voltage Vin (e.g., 5V˜20V) is less than or equal to the predetermined voltage (20V), the first power path P1 controlled by the bypass control circuit 150 may be conducted and the second power path P2 may be cut off, thereby improving the power conversion efficiency under light load. On the other hand, in the case where the input voltage Vin (e.g., 48V˜20V) is greater than the predetermined voltage (20V), the second power path P2 controlled by the buck conversion circuit 140 may be conducted and the first power path P1 may be cut off to convert the voltage value of the input voltage Vin to a converted voltage less than or equal to the predetermined voltage (20V), thereby replacing the buck-boost converter with the buck conversion circuit to reduce cost, while meeting the USB PD 3.1 charging protocol.

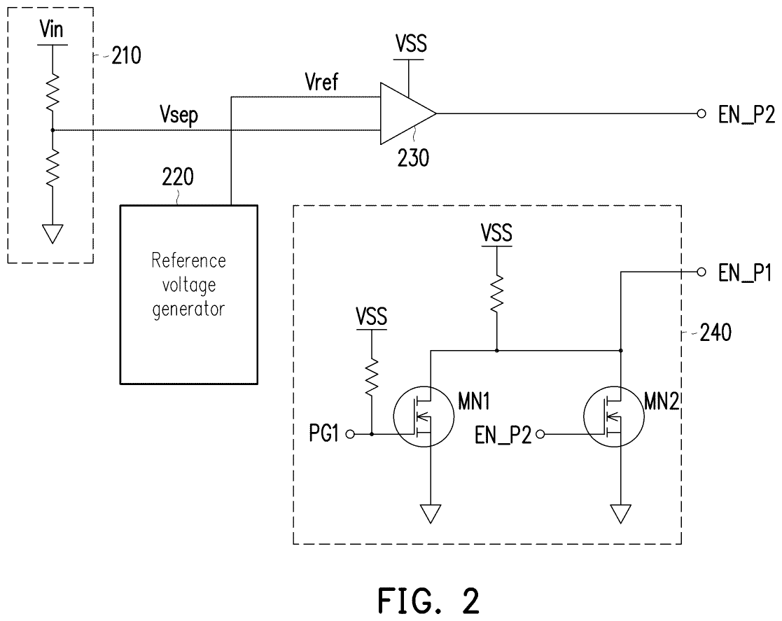

FIG. 2 is an exemplary circuit diagram of the voltage detection selector 120 in FIG. 1. Referring to FIG. 2, the voltage detection selector 120 includes a voltage divider circuit 210, a reference voltage generator 220, a comparator 230, and an activation logic circuit 240. The voltage divider circuit 210 is coupled to the voltage input terminal INN. The voltage divider circuit 210 is configured to generate dividing voltage Vsep according to the input voltage Vin.

The reference voltage generator 220 is configured to generate a reference voltage Vref. The first input terminal (non-inverting input terminal) of the comparator 230 receives the dividing voltage Vsep, and the second input terminal (inverting input terminal) of the comparator 230 receives the reference voltage Vref. The comparator 230 is configured to determine whether the dividing voltage Vsep is greater than the reference voltage Vref in order to provide a second enable signal EN_P2 at the output terminal of the comparator 230. In the case where the dividing voltage Vsep is greater than the reference voltage Vref, the second enable signal EN_P2 changes from disable to enable.

The activation logic circuit 240 receives the second enable signal EN_P2. The activation logic circuit 240 is configured to serve as a signal source provided for the first enable signal EN_P1 to change to a disable signal according to the second enable signal EN_P2 and the power good signal PG1 of the voltage conversion device 100. The power good signal PG1 of the voltage conversion device 100 is the signal that may be provided in the case where the voltage conversion device 100 is operating normally. In the case where the power good signal PG1 is enabled and the second enable signal EN_P2 is enabled, the first enable signal EN_P1 is disabled.

Specifically, the activation logic circuit 240 includes transistors MN1 and MN2, and the activation logic circuit 240 is configured as an inverter between the first enable signal EN_P1 and the second enable signal EN_P2. The control terminal (e.g., gate terminal) of the transistor MN2 receives the second enable signal EN_P2. Since the second enable signal EN_P2 is the output of the input voltage comparator 230, in the case where the second enable signal EN_P2 changes from a negative potential to the positive potential of the power good signal PG1, and the voltage level of the second enable signal EN_P2 rises above the threshold voltage of the gate terminal of the transistor MN2, two terminals of the transistor MN2 will be conducted to connect the source terminal of transistor MN2 to ground, while the first enable signal EN_P1 will be turned off due to grounding.

The first terminal (e.g., source terminal) of the transistor MN1 is further connected to the first enable signal EN_P1, and the control terminal (e.g., gate terminal) of the transistor MN1 is connected to the power good signal PG1. The transistor MN1 serves as a second safeguard for the inverter. When the voltage level of the power good signal PG1 rises above the threshold voltage of the gate terminal of the transistor MN1, two terminals of the transistor MN1 will be conducted to connect the source terminal of transistor MN1 to ground, while the first enable signal EN_P1 will be turned off due to grounding.

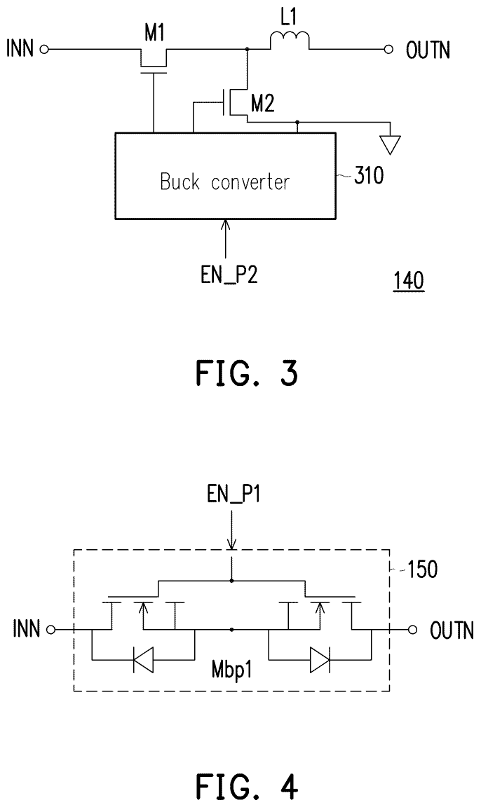

FIG. 3 is an exemplary circuit diagram of the buck conversion circuit 140 in FIG. 1. The buck conversion circuit 140 includes a buck converter 310, a first MOSFET M1, a second MOSFET M2, and a first inductor L1. The buck converter 310 receives the second enable signal EN_P2. The first terminal of the first MOSFET M1 is coupled to the voltage input terminal INN to receive the input voltage Vin. The control terminal of the first MOSFET M1 is coupled to the buck converter 310. The first terminal of the second MOSFET M2 is coupled to the second terminal of the first MOSFET M1. The control terminal of the second MOSFET M2 is coupled to the buck converter 310. The first terminal of the first inductor L1 is coupled to the second terminal of the first MOSFET M1 and the first terminal of the second MOSFET M2. The second terminal of the first inductor L1 is coupled to the voltage output terminal OUTN. In this embodiment, the second terminal of the second MOSFET M2 is coupled to the ground terminal.

FIG. 4 is an exemplary circuit diagram of the bypass control circuit 150 in FIG. 1. The bypass control circuit 150 includes a bypass control MOSFET Mbp1. The control terminal of the bypass control MOSFET Mbp1 receives the first enable signal EN_P1. The first terminal of the bypass control MOSFET Mbp1 is coupled to the voltage input terminal INN. The second terminal of the bypass control MOSFET Mbp1 is coupled to the voltage output terminal OUTN.

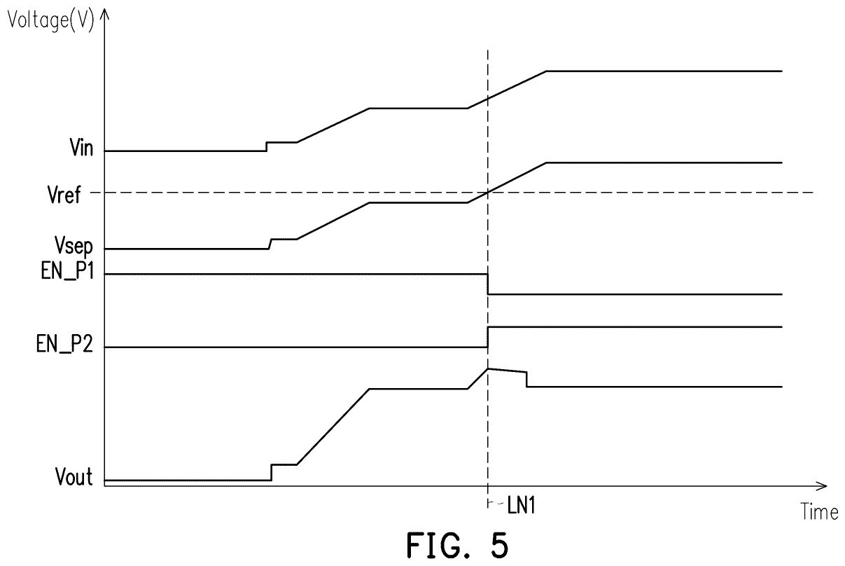

FIG. 5 is a schematic diagram of various signals in FIG. 2. F IG. 5 presents exemplary waveforms of the input voltage Vin, the dividing voltage Vsep, the first enable signal EN_P1, the second enable signal EN_P2, and the output voltage Vout. From FIG. 5, it can be seen that the first enable signal EN_P1 is preset to enable, and the second enable signal EN_P2 is preset to disable. Therefore, the first power path P1 is conducted and the second power path P2 is cut off. In the case where the voltage conversion device 100 starts up or an external power supply is connected to the input circuit 110 in FIG. 1, the voltage value of the input voltage Vin will gradually increase, and the dividing voltage Vsep will also increase accordingly.

In the case where the voltage value of the dividing voltage Vsep is higher than the reference voltage Vref (for example, at the time point when the voltage value of the dividing voltage Vsep reaches the predetermined voltage as shown by line LN1), the first enable signal EN_P1 changes from enable to disable, and the second enable signal EN_P2 changes from disable to enable. Therefore, the second power path P2 is conducted and the first power path P1 is cut off. As a result, the output voltage Vout will be adjusted to a converted voltage that is less than or equal to the predetermined voltage (20V).

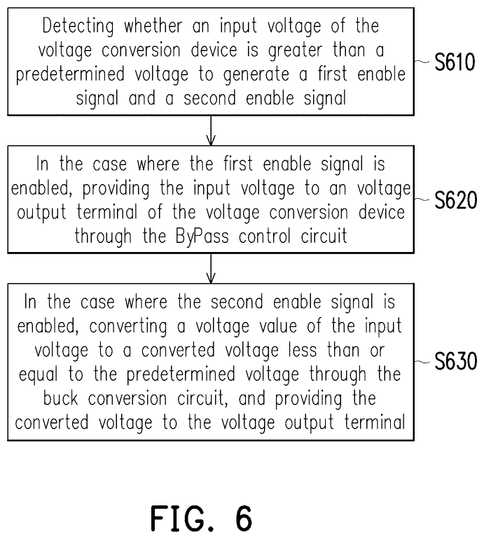

FIG. 6 is a flow chart of a method for power conversion according to an embodiment of the present disclosure. The method described in FIG. 6 is applicable to the voltage conversion device 100 including the buck conversion circuit 140 and the bypass control circuit 150 in FIG. 1. Please refer to both FIG. 1 and FIG. 6. In step S610, the input voltage Vin of the voltage conversion device 100 is detected to determine whether the input voltage Vin is greater than a predetermined voltage to generate the first enable signal EN_P1 and the second enable signal EN_P2. In the case where the input voltage Vin rises to be greater than the predetermined voltage (e.g., 20V), the first enable signal EN_P1 changes from enable to disable, and the second enable signal EN_P2 changes from disable to enable. In step S620, in the case where the first enable signal EN_P1 is enabled, the input voltage Vin is provided to the voltage output terminal OUTN of the voltage conversion device 100 through the bypass control circuit 150. In step S630, in the case where the second enable signal EN_P2 is enabled, the voltage value of the input voltage Vin is converted to a converted voltage that is less than or equal to the predetermined voltage (e.g., 20V) through the buck conversion circuit 140, and the converted voltage is provided to the voltage output terminal OUTN. For details of each step in the method described in FIG. 6, please refer to the aforementioned embodiments.

In summary, the power conversion device and the method for power conversion described in the embodiments of the present disclosure set up two power paths in the power conversion device. One power path may convert the input voltage to a converted voltage that is less than or equal to a predetermined voltage (e.g., 20V) through the buck conversion circuit, while the other power path may directly provide the input voltage to the voltage output terminal through the bypass control circuit. The voltage detection selector detects whether the input voltage is greater than the predetermined voltage (e.g., 20V) to selectively enable one of the aforementioned two power paths, thereby realizing the optimal power path selection under different input voltage ranges, improving the power conversion efficiency during light load, and complying with the USB PD 3.1 charging protocol.

Although the present disclosure has been disclosed by the above embodiments, it is not intended to limit the present disclosure. Any person skilled in the art may make some modifications and refinements without departing from the spirit and scope of the present disclosure. Therefore, the scope to be protected by the present disclosure should be defined by the appended claims.

What is claimed is:

1. A voltage conversion device, comprising:
a voltage input terminal, configured to obtain an input voltage;
a voltage output terminal, configured to provide an output voltage;
a voltage detection selector, coupled to the voltage input terminal, and configured to detect whether the input voltage is greater than a predetermined voltage to generate a first enable signal and a second enable signal, wherein in the case where the input voltage is greater than the predetermined voltage, the first enable signal changes from enable to disable, and the second enable signal changes from disable to enable;
a buck conversion circuit, coupled to the voltage input terminal and the voltage output terminal, wherein the buck conversion circuit is configured to receive the second enable signal, and in the case where the second enable signal is enabled, convert a voltage value of the input voltage to a converted voltage less than or equal to the predetermined voltage, and provide the converted voltage to the voltage output terminal; and
a bypass control circuit, coupled to the voltage input terminal and the voltage output terminal, wherein the bypass control circuit is configured to receive the first enable signal, and in the case where the first enable signal is enabled, provide the input voltage on the voltage input terminal to the voltage output terminal.

2. The voltage conversion device as claimed in claim 1, wherein the buck conversion circuit and the bypass control circuit provide a voltage to the voltage output terminal at different times.

3. The voltage conversion device as claimed in claim 1, wherein the first enable signal is preset to be enabled.

4. The voltage conversion device as claimed in claim 1, wherein the buck conversion circuit comprises:
a buck converter, receiving the second enable signal;
a first MOSFET, having a first terminal coupled to the voltage input terminal, wherein a control terminal of the first MOSFET is coupled to the buck converter;
a second MOSFET, having a first terminal coupled to a second terminal of the first MOSFET, wherein a control terminal of the second MOSFET is coupled to the buck converter; and
a first inductor, having a first terminal coupled to the second terminal of the first MOSFET and the first terminal of the second MOSFET, wherein a second terminal of the first inductor is coupled to the voltage output terminal.

5. The voltage conversion device as claimed in claim 1, wherein the bypass control circuit comprises:
a bypass control MOSFET, having a control terminal receiving the first enable signal, wherein a first terminal of the bypass control MOSFET is coupled to the voltage input terminal, and a second terminal of the bypass control MOSFET is coupled to the voltage output terminal.

6. The voltage conversion device as claimed in claim 1, wherein the voltage detection selector comprises:
a voltage divider circuit, coupled to the voltage input terminal, and configured to generate a dividing voltage according to the input voltage;
a reference voltage generator, configured to generate a reference voltage;
a comparator, having a first input terminal receiving the dividing voltage, wherein a second input terminal of the comparator receives the reference voltage, the comparator is configured to determine whether the dividing voltage is greater than the reference voltage to provide the second enable signal at an output terminal of the comparator, wherein in the case where the dividing voltage is greater than the reference voltage, the second enable signal changes from disable to enable; and
an activation logic circuit, receiving the second enable signal, and served as a signal source provided for the first enable signal changing to a disable signal according to the second enable signal and a power good signal of the voltage conversion device,
wherein in the case where the power good signal is enabled and the second enable signal is enabled, the first enable signal is disabled.

7. The voltage conversion device as claimed in claim 1, further comprising an input circuit coupled to the voltage input terminal,
wherein the input circuit comprises:
at least one universal serial bus port;
at least one input protection switch circuit, wherein a first terminal of the at least one input protection switch circuit is respectively coupled to an output terminal of the at least one universal serial bus port, a second terminal of the at least one input protection switch circuit is coupled to the voltage input terminal; and
a power delivery controller, coupled to the at least one input protection switch circuit.

8. The voltage conversion device as claimed in claim 1, further comprising:
a charging control device, coupled to the voltage output terminal, and configured to supply power to a system device based on a voltage on the voltage output terminal.

9. A method of power conversion, applicable to a voltage conversion device comprising a buck conversion circuit and a bypass control circuit, the method comprising:
detecting whether an input voltage of the voltage conversion device is greater than a predetermined voltage to generate a first enable signal and a second enable signal, wherein in the case where the input voltage is greater than the predetermined voltage, the first enable signal changes from enable to disable, and the second enable signal changes from disable to enable;
in the case where the first enable signal is enabled, providing the input voltage to an voltage output terminal of the voltage conversion device through the bypass control circuit; and
in the case where the second enable signal is enabled, converting a voltage value of the input voltage to a converted voltage less than or equal to the predetermined voltage through the buck conversion circuit, and providing the converted voltage to the voltage output terminal.

10. The method as claimed in claim 9, wherein the step of detecting whether the input voltage of the voltage conversion device is greater than the predetermined voltage comprises:
dividing the input voltage to generate a dividing voltage;
determining whether the dividing voltage is greater than a reference voltage to provide the second enable signal, wherein in the case where the dividing voltage is greater than the reference voltage, the second enable signal changes from disable to enable; and
serving as a signal source provided for the first enable signal to change to a disable signal according to the second enable signal and a power good signal of the voltage conversion device,
wherein in the case where the power good signal is enabled and the second enable signal is enabled, the first enable signal is disabled.
